(19) United States
(12) Patent Application Publication
(10) Pub. No.: US 2025/0083482 A1
(43) Pub. Date: Mar. 13, 2025

(54) VEHICLE-MOUNTED EXPANSION BRACKET

(71) Applicant: ZhongShan ZhaoSheng Metal Products Co., Ltd, Guangdong (CN)

(72) Inventor: Cheng PENG, Guangdong (CN)

(21) Appl. No.: 18/502,429

(22) Filed: Nov. 6, 2023

(30) Foreign Application Priority Data
Sep. 13, 2023 (CN) 2023111840793

(51) Int. Cl. B60D 1/54; B60D 1/04

(52) U.S. Cl. CPC B60D 1/54; B60D 1/04

(57) ABSTRACT

A vehicle-mounted expansion bracket is disclosed, including a mounting rod, configured for being inserted into a trailer hook of a vehicle; a jacking member, rotatably arranged on the mounting rod, where the jacking member is operable in a first working state where the jacking member is rotated relative to the mounting rod to abut against an inner wall of the trailer hook and a second working state where the jacking member is rotated to separate from the inner wall of the trailer hook; and a driving device, arranged on the mounting rod, contacted with the jacking member, and capable of driving the jacking member to rotate and keep in the first working state.

### CROSS-REFERENCE TO RELATED APPLICATION

This application is based on and claims the benefit of priority from Chinese Patent Application No. 2023111840793, filed on 13 Sep. 2023, the entirety of which is incorporated by reference herein.

### TECHNICAL FIELD

The present disclosure relates to the technical field of vehicle-mounted tools, and in particular to a vehicle-mounted expansion bracket.

### BACKGROUND

In the prior art, rear portions of some vehicles are fixedly provided with square tubular connectors, the connectors are usually called trailer hooks. In order to make full use of a space at the rear portion of the vehicle to transport objects, a vehicle-mounted bracket detachably mounted on the trailer hook is usually configured for carrying the objects. The traditional vehicle-mounted bracket comprises a connecting rod being capable of being inserted into the trailer hook, and the connecting rod and the trailer hook are connected with each other via a bolt transversely penetrating through the connecting rod, so that the connecting rod and the trailer hook are easy to shake relative to each other during the running of the vehicle, thus resulting in poor stability.

In addition, the connecting rod of the vehicle-mounted bracket has a fixed diameter, and is only applicable to the trailer hook of the corresponding size. Even if the connecting rod is assembled to the trailer hook of the corresponding size, the connecting rod may not stably abut against the inner peripheral wall of the trailer hook due to expansion or a dimensional error caused by long-term use, thus resulting in extremely poor connection stability.

### SUMMARY

The present disclosure aims at solving at least one of the technical problems in the prior art. For this purpose, the present disclosure proposes a vehicle-mounted expansion bracket, which is simple in structure, is convenient to mount and dismount, is stable in connection, and has a wide range of application.

A vehicle-mounted expansion bracket, according to embodiments of the present disclosure, comprises: a mounting rod, configured for being inserted into a trailer hook of a vehicle; a jacking member, rotatably arranged on the mounting rod, wherein the jacking member is operable in a first working state where the jacking member is rotated relative to the mounting rod to abut against an inner wall of the trailer hook and a second working state where the jacking member is rotated to separate from the inner wall of the trailer hook; and a driving device, arranged on the mounting rod, contacted with the jacking member, and capable of driving the jacking member to rotate and keep in the first working state.

The vehicle-mounted expansion bracket, according to embodiments of the present disclosure, at least has the following beneficial effects.

When the vehicle-mounted expansion bracket is mounted in the trailer hook, one end of the mounting rod is inserted into the trailer hook, and the driving device is used for driving the jacking member to rotate to protrude out of a side wall of the mounting rod and lock a position of the jacking member, thereby enabling the jacking member to keep in the first working state of abutting against the inner wall of the trailer hook. When the vehicle-mounted expansion bracket is dismounted, it only needs to use the driving device to drive the jacking member to rotate to separate from the inner wall of the trailer hook. The above-mentioned vehicle-mounted expansion bracket is simple in structure, is convenient to mount and dismount, is stable in connection, and is suitable for the trailer hooks of various sizes and specifications.

In some embodiments of the present disclosure, the mounting rod has an axial direction, a mounting channel is arranged in the mounting rod along the axial direction of the mounting rod, a side wall at one end of the mounting rod is provided with a through hole communicated with the mounting channel, one end of the jacking member is rotatably arranged in the mounting channel, the other end of the jacking member extends out of a peripheral wall of the mounting rod along the through hole to abut against the inner wall of the trailer hook, and the driving device is at least partially arranged in the mounting channel and abuts against the jacking member.

In some embodiments of the present disclosure, the driving device comprises an abutting block slidably arranged in the mounting channel, a driving rod penetrating through the mounting channel and connected with the abutting block, and a locking structure for locking a position of the abutting block, one of the abutting block and the jacking member is provided with a first driving inclined plane obliquely arranged along the axial direction of the mounting rod, and the other thereof is provided with a contact portion matched with the first driving inclined plane, and the abutting block drives the jacking member to extend out of the through hole through the matching of the first driving inclined plane and the contact portion when sliding.

In some embodiments of the present disclosure, the first driving inclined plane is arranged on the abutting block, and the contact portion is a second driving inclined plane arranged on the jacking member and attached to the first driving inclined plane.

In some embodiments of the present disclosure, the mounting channel penetrates through both ends of the mounting rod, one end of the mounting rod is provided with a first connecting base, one end of the driving rod is provided with a threaded column section, the abutting block is provided with an inner threaded hole matched with the threaded column section, and the other end of the driving rod movably penetrates through the first connecting base and is only capable of rotating relative to the first connecting base.

In some embodiments of the present disclosure, one end of the driving rod penetrating through the first connecting base is provided with a rotating handle, and a clutch mechanism is arranged between the rotating handle and the driving rod.

In some embodiments of the present disclosure, the clutch mechanism comprises a first clutch fixedly arranged at one end of the driving rod far away from the abutting block, a second clutch movably arranged on the rotating handle and a mechanical lock cylinder arranged on the rotating handle, the first clutch comprises a sleeve portion and a first meshing portion, the rotating handle is rotatable freely around the sleeve portion, the second clutch is arranged at an output end of the mechanical lock cylinder, and the second clutch is provided with a second meshing portion capable of being engaged with the first meshing portion and an avoidance portion separated from the first meshing portion.

In some embodiments of the present disclosure, the jacking member is rotatably connected with the mounting rod through a pivot perpendicular to the axial direction of the mounting rod, one end of the jacking member close to the pivot is provided with an extension portion, and the abutting block is abutted against with the extension portion to drive the jacking member to extract in the mounting channel along the through hole.

In some embodiments of the present disclosure, the mounting rod is a square rod, the through hole is arranged in two adjacent side walls and an edge line of the two adjacent side walls of the square rod, the jacking member is provided with a first abutting surface and a second abutting surface respectively corresponding to the two adjacent side walls of the square rod, and the first abutting surface and the second abutting surface are configured for abutting against the two adjacent inner side walls of the trailer hook.

In some embodiments of the present disclosure, an L-shaped plate is detachably mounted on two adjacent outer side walls of the square rod, a cross section integrally formed by the L-shaped plate and the square rod is a first rectangle, and the first rectangle is adaptive to the trailer hook.

The additional aspects and advantages of the present disclosure will be partially given in the following description, and will be partially apparent from the following description, or will be understood via the practice of the present disclosure.

### BRIEF DESCRIPTION OF THE DRAWINGS

The above and/or additional aspects and advantages of the present disclosure will be more apparent from the following description of the embodiments in conjunction with the accompanying drawings, wherein:

FIG. 1 is a structural schematic diagram of a vehicle-mounted expansion bracket according to an embodiment of the present disclosure;

FIG. 2 is a cross-sectional view showing interior of the structure of the embodiment in FIG. 1;

FIG. 3 is a local structural schematic diagram of the embodiment in FIG. 1; and

FIG. 4 is an explosive view showing a driving rod, a rotating handle and a clutch structure of the embodiment in FIG. 1.

### DETAILED DESCRIPTION

The embodiments of the present disclosure will be described in detail hereinafter. Examples of the embodiments are shown in the accompanying drawings. The same or similar reference numerals throughout denote the same or similar elements or elements having the same or similar functions. The embodiments described below with reference to the accompanying drawings are exemplary and are only intended to explain the present disclosure, but should not be construed as limiting the present disclosure.

In the description of the present disclosure, it should be understood that the orientation or position relation related to the orientation description, such as the orientation or position relation indicated by the terms upper, lower, front, rear, left, right, vertical, horizontal, top, bottom, inner, outer etc., is based on the orientation or position relation shown in the drawings, which is only used for convenience of description of the present disclosure and simplification of description instead of indicating or implying that the indicated device or element must have a specific orientation, and be constructed and operated in a specific orientation, and thus shall not be understood as a limitation to the present disclosure.

In the description of the present disclosure, the meaning of several is one or more, and the meaning of multiple is two or more. Greater than, less than and exceeding are understood as excluding the number, and above, below and within are understood as including the number. If first and second are described, the descriptions are used for the purpose of distinguishing the technical features only, and cannot be understood as indicating or implying relative importance, or implicitly indicating the number of technical features indicated thereby, or implicitly indicating the order of technical features indicated thereby.

In the description of the present disclosure, it should be denoted that, unless otherwise clearly stated and defined, words such as installation, interconnection, connection, and the like, shall be understood broadly. For example, it may be a fixed connection, a detachable connection, or an integral connection; it may also be a mechanical connection or an electrical connection; it may be a direct connection, may also be an indirect connection through an intermediate medium, and may be a connection inside two elements. Those having ordinary skills in the art can reasonably determine the specific meanings of the above words in the present disclosure in combination with the specific contents of the technical solution.

Referring to FIG. 1 to FIG. 4, a vehicle-mounted expansion bracket in the present disclosure, comprises: a mounting rod 100, configured for being inserted into a trailer hook 10 of a vehicle, wherein the mounting rod 100 is provided with a connecting bracket, a clamping device and the like for placing objects; a jacking member 200, rotatably arranged on the mounting rod 100, wherein the jacking member 200 is operable in a first working state where the jacking member 200 is rotated relative to the mounting rod 100 to abut against an inner wall of the trailer hook 10 and a second working state where the jacking member 200 is rotated to separate from the inner wall of the trailer hook 10; and a driving device 300, arranged on the mounting rod 100, contacted with the jacking member 200, and capable of driving the jacking member 200 to rotate and keep in the first working state.

When the vehicle-mounted expansion bracket is mounted in the trailer hook 10, one end of the mounting rod 100 is inserted into the trailer hook 10, and the driving device 300 is used for driving the jacking member 200 to rotate to protrude out of a side wall of the mounting rod 100 and lock a position of the jacking member 200, thereby enabling the jacking member 200 to keep in the first working state of abutting against the inner wall of the trailer hook 10, and when the vehicle-mounted expansion bracket is dismounted, it only needs to use the driving device 300 to drive the jacking member 200 to rotate to separate from the inner wall of the trailer hook 10; the above-mentioned vehicle-mounted expansion bracket is simple in structure, is convenient to mount and dismount, is stable in connection, and is suitable for the trailer hooks 10 of various sizes and specifications.

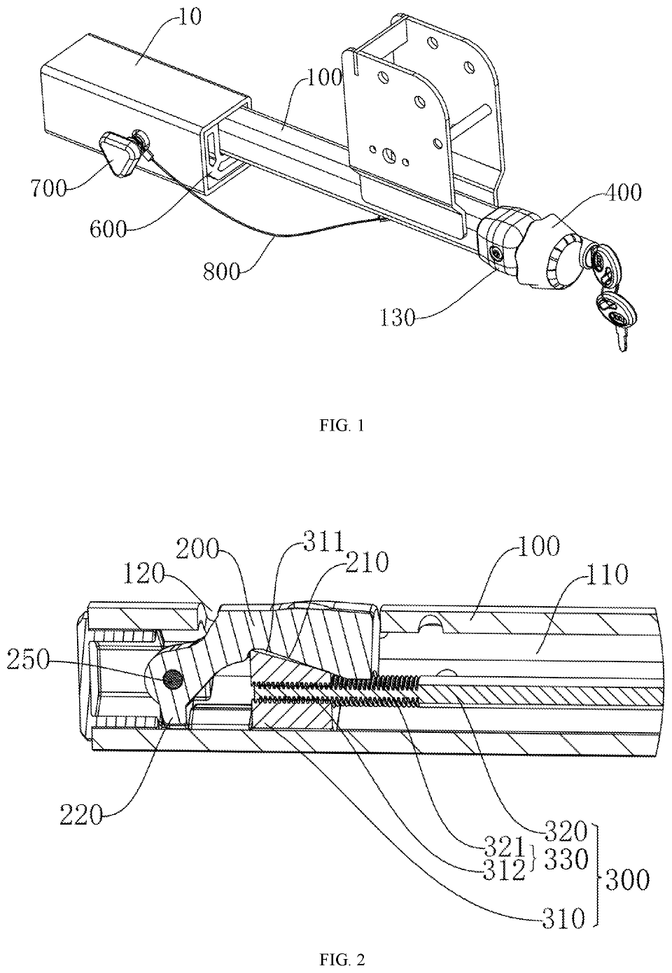

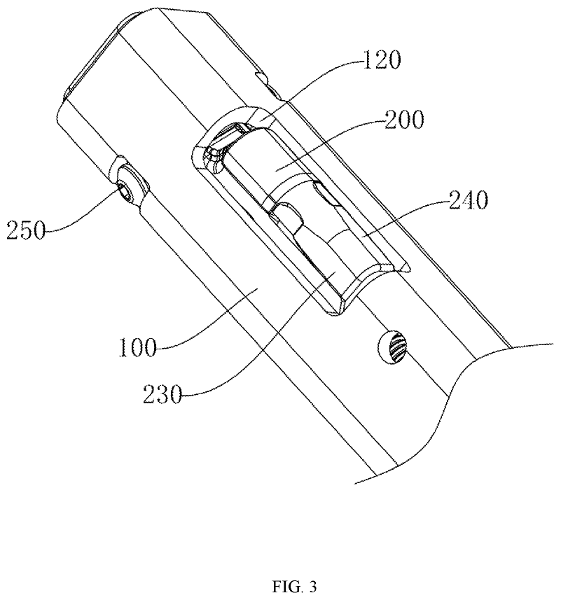

Referring to FIG. 1 and FIG. 2, in some embodiments of the present disclosure, the mounting rod 100 has an axial direction, and has a mounting channel 110 arranged along the axial direction of the mounting rod 100, a side wall at one end of the mounting rod 100 is provided with a through hole 120 communicated with the mounting channel 110, one end of the jacking member 200 is rotatably arranged in the mounting channel 110, the other end of the jacking member 200 extends out of a peripheral wall of the mounting rod 100 along the through hole 120 to abut against the inner wall of the trailer hook 10, and the driving device 300 is at least partially arranged in the mounting channel 110 and abuts against the jacking member 200. The positioning of the jacking member 200 and part or all of the driving device 300 in the mounting channel 110 is beneficial to improving the structural compactness, protecting the movement of the jacking member 200 and the driving device 300 from interference with each other, and setting the mounting rod 100 in a state of clearance fit with the inner wall of the trailer hook 10. When the jacking member 200 extends out of the through hole 120, the contact between the mounting rod 100 and the trailer hook 10 in all directions is very stable and reliable. It should be noted that the part of the driving device 300 abutting against the jacking member 200 can drive the jacking member 200 to rotate to extend out along the through hole 120 and abut against the inner wall of the trailer hook 10, thus stabilizing the jacking member 200 in the first working state. Of course, in other embodiments, the jacking member 200 and the driving device 300 may also be arranged on an outer side wall of the mounting rod 100, so that when the driving device 300 drives the jacking member 200 to rotate to protrude from the other side wall of the mounting rod 100, the jacking member can also abut against the trailer hook 10.

Referring to FIG. 2, in some embodiments of the present disclosure, the driving device 300 comprises an abutting block 310 slidably arranged in the mounting channel 110, a driving rod 320 penetrating through the mounting channel 110 and connected with the abutting block 310, and a locking structure 330 for locking a position of the abutting block 310, one of the abutting block 310 and the jacking member 200 is provided with a first driving inclined plane 311 obliquely arranged along the axial direction of the mounting rod 100, and the other thereof is provided with a contact portion 210 matched with the first driving inclined plane 311, and the abutting block 310 drives the jacking member 200 to extend out of the through hole 120 through the matching of the first driving inclined plane 311 and the contact portion 210 when sliding. It may be understood that when the abutting block 310 slides along the mounting channel 110, the first driving inclined surface 311 and the contact portion 210 may cooperate to push the jacking member 200 to generate a displacement by extending out of the mounting rod 100 along the through hole 120, and the driving device 300 is simple in structure and convenient to operate. The mounting channel 110 is a long rectangular groove, and the abutting block 310 is provided with two guide surfaces matched with two adjacent side walls of the rectangular groove, so that the abutting block 310 can slide along the mounting channel 110, and no other guide limiting structure is required.

Referring to FIG. 2, in some embodiments of the present disclosure, the first driving inclined plane 311 is arranged on the abutting block 310, and the contact portion 210 is a second driving inclined plane arranged on the jacking member 200 and attached to the first driving inclined plane 311. A contact area between the first driving inclined plane 311 and the second driving inclined plane is large, which is beneficial to stably maintaining the jacking member 200 in the first working state.

Referring to FIG. 2, in some embodiments of the present disclosure, the mounting channel 110 penetrates through both ends of the mounting rod 100, one end of the mounting rod 100 is provided with a first connecting base 130, one end of the driving rod 320 is provided with a threaded column section 321, the abutting block 310 is provided with an inner threaded hole 312 matched with the threaded column section 321, and the other end of the driving rod 320 movably penetrates through the first connecting base 130 and can only rotates relative to the first connecting base 130. It should be noted that the threaded column section 321 and the inner threaded hole 312 constitute the locking structure 330. When the driving rod 320 rotates, the inner threaded hole 312 moves relative to the threaded column section 321, so that the abutting block 310 slides back and forth along an extension direction of the mounting channel 110. When the abutting block 310 slides, the first driving inclined surface 311 pushes the second driving inclined surface, and the jacking member 200 can generate a displacement along a radial direction of the mounting rod 100, so as to abut the jacking member 200 against the inner wall of the trailer hook 10. When the driving rod 320 stops rotating, the threaded column section 321 and the inner threaded hole 312 can cooperatively lock the position of the abutting block 310 in the mounting channel 110.

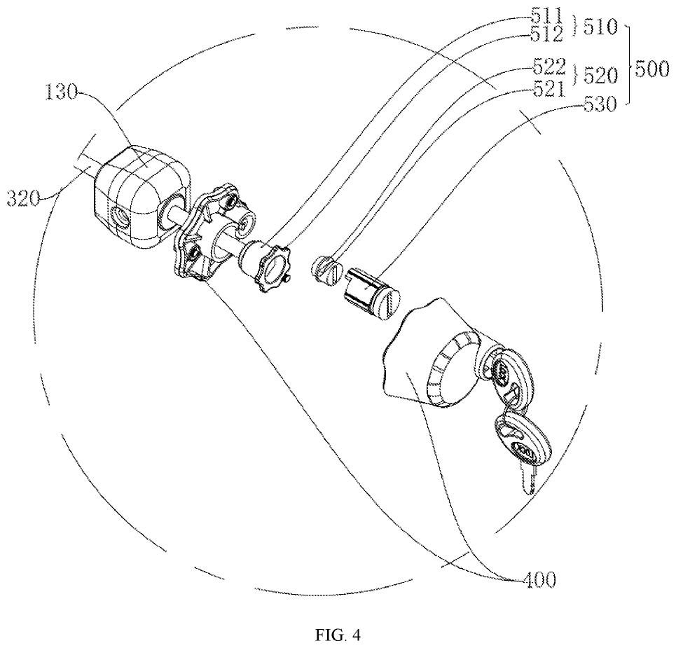

Referring to FIG. 1 and FIG. 4, in some embodiments of the present disclosure, one end of the driving rod 320 penetrating through the first connecting base 130 is provided with a rotating handle 400, and a clutch mechanism 500 is arranged between the rotating handle 400 and the driving rod 320. The rotating handle 400 is conducive to the manual operation of a user to mount and dismount the vehicle-mounted expansion bracket, and the setting of the clutch mechanism 500 can prevent a problem that the jacking member 200 does not abut against the inner wall of the trailer hook 10 due to that the rotating handle 400 is mistakenly operated by an outer force.

Referring to FIG. 4, in some embodiments of the present disclosure, the clutch mechanism 500 comprises a first clutch 510 fixedly arranged at one end of the driving rod 320 far away from the abutting block 310, a second clutch 520 movably arranged on the rotating handle 400 and a mechanical lock cylinder 530 arranged on the rotating handle 400, the first clutch 510 comprises a sleeve portion 511 and a first meshing portion 512, the rotating handle 400 is rotatable freely around the sleeve portion 511, the second clutch 520 is arranged at an output end of the mechanical lock cylinder 530, and the second clutch 520 is provided with a second meshing portion 521 capable of being engaged with the first meshing portion 512 and an avoidance portion 522 separated from the first meshing portion 512. When the vehicle-mounted expansion bracket needs to be mounted or dismounted, the user inserts a key into the mechanical lock cylinder 530 to unlock, and the second meshing portion 521 on the second clutch 520 can be engaged with the first meshing portion 512 on the first clutch 510. At this time, the rotating handle 400 may be rotated to drive the driving rod 320 to rotate. When the user inserts the key into the mechanical lock cylinder 530 to lock, the second meshing portion 521 on the second clutch 520 is separated from the first meshing portion 512 on the first clutch 510, and the avoidance portion 522 is arranged opposite to the first meshing portion 512. At this time, when the rotating handle 400 is rotated, the rotating handle 400 idles relative to the driving rod 320, and the driving rod 320 cannot be driven to rotate, thereby preventing the vehicle-mounted expansion bracket from loosening and being stolen.

Referring to FIG. 2, in some embodiments of the present disclosure, the jacking member 200 is rotatably connected with the mounting rod 100 through a pivot 250 perpendicular to the axial direction of the mounting rod 100, one end of the jacking member 200 close to the pivot 250 is provided with an extension portion 220, and the abutting block 310 is abutted against with the extension portion 220 to drive the jacking member 200 to extract in the mounting channel 110 along the through hole 120. It should be noted that when the abutting block 310 slides to a position where the jacking member 200 no longer abuts against the trailer hook 10, the jacking member 200 will not automatically retract to the second working state along the through hole 120, which will affect the smooth pulling out of the mounting rod 100 from the trailer hook 10. However, the above jacking member 200 is provided with the extension portion 220, which can act on the extension portion 220 synchronously when the abutting block 310 slides, thus driving the jacking member 200 to rotate to extract in the mounting channel 110, without setting a spring to help the jacking member 200 restore to the second working state. In this way, the structure is very ingenious.

Referring to FIG. 3, in some embodiments of the present disclosure, in order to ensure that the jacking member 200 can stably abut against the inner wall of the trailer hook 10, the mounting rod 100 is a square rod, the through hole 120 is arranged in two adjacent side walls and an edge line of the two adjacent side walls of the square rod, the jacking member 200 is provided with a first abutting surface 230 and a second abutting surface 240 respectively protruding out of the two adjacent side walls of the square rod, and the first abutting surface 230 and the second abutting surface 240 are configured for abutting against the two adjacent inner side walls of the trailer hook 10.

Referring to FIG. 1, in some embodiments of the present disclosure, an L-shaped plate 600 is detachably mounted on two adjacent outer side walls of the square rod, a cross section integrally formed by the L-shaped plate 600 and the square rod is a first rectangle, and the first rectangle is adaptive to the trailer hook 10. It should be noted that, according to the trailer hooks 10 of different shapes and specifications, the user may replace L-shaped plates of different sizes and specifications, so that the whole component consisting of the L-shaped plate 600 and the square rod forms a clearance fit when being inserted into the trailer hook 10, which is beneficial to improving the stability of the vehicle-mounted expansion bracket of the present disclosure mounted on the trailer hook 10. Preferably, in order to further prevent the vehicle-mounted expansion bracket from accidentally dropping from the trailer hook 10, an anti-dropping plug-in 700 is further inserted between the L-shaped plate 600 and the trailer hook 10, and the anti-dropping plug-in 700 is connected with one end of a steel wire rope 800, and the other end of the steel wire rope 800 is connected with a middle portion of the mounting rod 100.

The technical features of the above embodiments may be combined arbitrarily. In order to make the description concise, not all possible combinations of the technical features in the above embodiments are described. However, as long as there is no contradiction between the combinations of these technical features, they should be considered as the scope recorded in this specification.

Although the embodiments of the present disclosure have been illustrated and described, those having ordinary skills in the art should understand that various changes, modifications, substitutions and variations can still be made to these embodiments without departing from the principles and purposes of the present disclosure, and the scope of the present disclosure is defined by the claims and equivalents thereof.

What is claimed is:

1. A vehicle-mounted expansion bracket, comprising:
a mounting rod, configured for being inserted into a trailer hook of a vehicle;
a jacking member, rotatably arranged on the mounting rod, wherein the jacking member is operable in a first working state where the jacking member is rotated relative to the mounting rod to abut against an inner wall of the trailer hook and a second working state where the jacking member is rotated to separate from the inner wall of the trailer hook; and
a driving device, arranged on the mounting rod, contacted with the jacking member, and capable of driving the jacking member to rotate and keep in the first working state.

2. The vehicle-mounted expansion bracket according to claim 1, wherein:
the mounting rod has an axial direction, a mounting channel is arranged in the mounting rod along the axial direction of the mounting rod, a side wall at one end of the mounting rod is provided with a through hole communicated with the mounting channel, one end of the jacking member is rotatably arranged in the mounting channel, the other end of the jacking member is capable of extending out of a peripheral wall of the mounting rod along the through hole to abut against the inner wall of the trailer hook, and the driving device is at least partially arranged in the mounting channel and abuts against the jacking member.

3. The vehicle-mounted expansion bracket according to claim 2, wherein:
the driving device comprises an abutting block slidably arranged in the mounting channel, a driving rod penetrating through the mounting channel and connected with the abutting block, and a locking structure for locking a position of the abutting block, one of the abutting block and the jacking member is provided with a first driving inclined plane obliquely arranged along the axial direction of the mounting rod, and the other of the abutting block and the jacking member is provided with a contact portion matched with the first driving inclined plane, and the abutting block is capable of driving the jacking member to extend out of the through hole through the matching of the first driving inclined plane and the contact portion when sliding.

4. The vehicle-mounted expansion bracket according to claim 3, wherein:
the first driving inclined plane is arranged on the abutting block, and the contact portion is a second driving inclined plane arranged on the jacking member and attached to the first driving inclined plane.

5. The vehicle-mounted expansion bracket according to claim 3, wherein:
the mounting channel penetrates through both ends of the mounting rod, one end of the mounting rod is provided with a first connecting base, one end of the driving rod is provided with a threaded column section, the abutting block is provided with an inner threaded hole matched with the threaded column section, and the other end of the driving rod movably penetrates through the first connecting base and is only capable of rotating relative to the first connecting base.

6. The vehicle-mounted expansion bracket according to claim 5, wherein:
one end of the driving rod penetrating through the first connecting base is provided with a rotating handle, and a clutch mechanism is arranged between the rotating handle and the driving rod.

7. The vehicle-mounted expansion bracket according to claim 6, wherein:
the clutch mechanism comprises a first clutch fixedly arranged at one end of the driving rod far away from the abutting block, a second clutch movably arranged on the rotating handle and a mechanical lock cylinder arranged on the rotating handle, the first clutch comprises a sleeve portion and a first meshing portion, the rotating handle is rotatable freely around the sleeve portion, the second clutch is arranged at an output end of the mechanical lock cylinder, and the second clutch is provided with a second meshing portion capable of being engaged with the first meshing portion and an avoidance portion separated from the first meshing portion.

8. The vehicle-mounted expansion bracket according to claim 3, wherein:
the jacking member is rotatably connected with the mounting rod through a pivot perpendicular to the axial direction of the mounting rod, one end of the jacking member close to the pivot is provided with an extension portion, and the abutting block is abutted against with the extension portion to drive the jacking member to extract in the mounting channel along the through hole.

9. The vehicle-mounted expansion bracket according to claim 2, wherein:
the mounting rod is a square rod, the through hole is arranged in two adjacent side walls and an edge line of the two adjacent side walls of the square rod, the jacking member is provided with a first abutting surface and a second abutting surface respectively corresponding to the two adjacent side walls of the square rod, and the first abutting surface and the second abutting surface are configured for abutting against the two adjacent inner side walls of the trailer hook.

10. The vehicle-mounted expansion bracket according to claim 9, wherein:
an L-shaped plate is detachably mounted on two adjacent outer side walls of the square rod, a cross section integrally formed by the L-shaped plate and the square rod is a first rectangle, and the first rectangle is adaptive to the trailer hook.
